(19) United States
(12) Patent Application Publication
(10) Pub. No.: US 2025/0065763 A1
(43) Pub. Date: Feb. 27, 2025

(54) BRANCH APPARATUS AND SYSTEM

(71) Applicant: Ubiden, Inc., Tokyo (JP)

(72) Inventors: Norio Yamaguchi, Tokyo (JP); Tatsuro Shiraishi, Tokyo (JP); Shuhei Onishi, Tokyo (JP); Hitoshi Ikeda, Tokyo (JP)

(73) Assignee: Ubiden, Inc., Tokyo (JP)

(21) Appl. No.: 18/455,723

(22) Filed: Aug. 25, 2023

(51) Int. Cl. B60L 53/66; B60L 53/14; B60L 53/30; H02J 3/14; H02J 7/02

(52) U.S. Cl. CPC B60L 53/665; B60L 53/14; B60L 53/305; H02J 3/14; H02J 7/02

(57) ABSTRACT

In case of branching a primary-side energy supply path into a plurality of secondary-side energy supply paths to supply energy to a plurality of supply targets, the energy supply to the plurality of supply targets is remotely monitored and efficiently controlled. A branch apparatus branches the primary-side energy supply path into the plurality of secondary-side energy supply paths. The branch apparatus is provided with secondary-side measurement means for measuring an energy supply status in each of the plurality of secondary-side energy supply paths, opening/closing means for opening and closing each of the plurality of secondary-side energy supply paths, and control means for transmitting information of measurement results of the secondary-side measurement means to a management apparatus and controlling the opening/closing means to individually open and close each of the plurality of secondary-side energy supply paths based on the control information received from the management apparatus.

### TECHNICAL FIELD

The present invention relates to a branch apparatus and a system for branching an energy such as an electric power and the like used for vehicle charging, etc.

### BACKGROUND ART

There is conventionally known a system in which an energy such as an electric power and the like supplied from an energy source such as an electric power source, etc. is branched and supplied to supply targets such as a plurality of vehicles and the like. For example, Patent Literature 1 discloses a system provided with an electric-power output apparatus that branches an electric power supplied from an external-electric power line and outputs it from a plurality of electrical outlets used for vehicle charging via a plurality of electric power lines.

### CITATION LIST

### Patent Literature

Patent Literature 1: Japanese Unexamined Patent Application Publication No. 2010-284039.

### SUMMARY OF INVENTION

### Technical Problem

In case of supplying an electric power to supply targets such as a plurality of vehicles and the like by branching an electric power line of primary side on an electric-power source side (hereinafter also referred to as “primary-side electric power line”) into a plurality of electric power lines of secondary side (hereinafter also referred to as “secondary-side electric power line”) as in the conventional system described above, since there is a limit to an amount of electric power that can be supplied to the plurality of supply targets at the same time, there is a problem that it is desired to remotely monitor and efficiently control the electric power supply to the plurality of supply targets. It is noted that such a problem may similarly arise in case of supplying an energy other than the electric power.

### Solution to Problem

A branch apparatus according to an aspect of the present invention is a branch apparatus that branches a primary-side energy supply path into a plurality of secondary-side energy supply paths. This branch apparatus comprises secondary-side measurement means for measuring an energy supply status in each of the plurality of secondary-side energy supply paths, opening/closing means for opening and closing each of the plurality of secondary-side energy supply paths, and control means for transmitting information of measurement results of the secondary-side measurement means to a management apparatus, receiving control information generated based on the information of the measurement results of the secondary-side measurement means, from the management apparatus, and controlling the opening/closing means to individually open and close each of the plurality of secondary-side energy supply paths based on the control information.

In the foregoing branch apparatus, the branch apparatus may comprise primary-side measurement means for measuring energy supply status in the primary-side energy supply path, and the control means may transmit information of measurement results of the primary-side measurement means to the management apparatus, receive control information generated based on the information of the measurement results of the primary-side measurement means, from the management apparatus, and control the opening/closing means to individually open and close each of the plurality of secondary-side energy supply paths based on the control information.

Herein, the primary-side measurement means may measure an amount of energy supply in the primary-side energy supply path, and the control means may control the opening/closing means so as to close at least one of the plurality of secondary-side energy supply paths when a measurement result of the amount of energy supply in the primary-side energy supply path exceeds a predetermined threshold value, or when the measurement result is predicted to exceed the threshold value.

In the foregoing branch apparatus, the control information may include information of priority ranking of energy supply to each of the plurality of secondary-side energy supply paths, and the control means may control the opening/closing means to preferentially supply an energy to a part of the plurality of secondary-side energy supply paths based on the information of the priority ranking received from the management apparatus.

In the foregoing branch apparatus, the control information may include information of interruptive energy supply in the plurality of secondary-side energy supply paths, and the control means may stop an energy supply to a secondary-side energy supply path that is currently supplying an energy, among the plurality of secondary-side energy supply paths based on the information of interruptive energy supply received from the management apparatus, and control the opening/closing means so as to start an energy supply to another secondary-side energy supply path that is stopping the energy supply.

In the foregoing branch apparatus, the control means may receive, from the management apparatus, control information that is generated based on at least one of information of supply target to which an electric power is supplied via the secondary-side energy supply path and information of the measurement results of the secondary-side measuring means, and may control the opening/closing means to individually open and close each of the plurality of secondary-side energy supply paths based on the control information.

In the foregoing branch apparatus, the energy supplied via the secondary-side energy supply path may be an electrical energy used for charging a battery mounted on a vehicle, each of the primary-side energy supply path and the plurality of secondary-side energy supply paths may be an electric power line, and the energy supply status to be measured may be an electric power, an electric current or an amount of electric power.

A system according to another aspect of the present invention is a system for providing a power charging service of a vehicle. This system comprises the foregoing branch apparatus, a management apparatus capable of communicating with the branch apparatus via a communication network, and a plurality of electric-power output sections for outputting an electric power supplied via each of the plurality of secondary-side energy supply paths. The management apparatus comprises information receiving means for receiving information of the measurement results from the branch apparatus, information generating means for generating control information for individually opening and closing each of the plurality of secondary-side energy supply paths based on the information of the measurement results, and information transmitting means for transmitting the control information to the branch apparatus.

In the foregoing system, the management apparatus may comprise fee-charging processing means for performing a process of fee-charging a usage fee for power charging by the vehicle via the electric-power output section to at least one of the user of the power charging service of the vehicle, the vehicle, a battery installed in the vehicle and a terminal apparatus operated by the user, based on the information of the measurement results of the secondary-side measurement means, for each of the plurality of electric-power output sections.

### Advantageous Effects of Invention

According to the present invention, in case of branching a primary-side energy supply path into a plurality of secondary-side energy supply paths and supplying an energy to a plurality of supply targets, it is capable of remotely monitoring and efficiently controlling the energy supply to the plurality of supply targets.

### BRIEF DESCRIPTION OF DRAWINGS

FIG. 1 is an illustration showing an example of an overall schematic configuration of a charging-service management system according to an embodiment.

FIG. 2 is an illustration showing an example of a main part configuration of a charging-service management system according to the embodiment.

Each of FIG. 3(a) to FIG. 3(c) is an illustration showing an example of an image attached to an electrical outlet according to the embodiment.

FIG. 4 is a block diagram showing an example of a configuration of main functions of a power-charging management server according to the embodiment.

FIG. 5 is an illustration showing an example of a configuration of a charging HUB apparatus according to the embodiment.

FIG. 6 is a flowchart showing an example of a process of a provision of power-charging service according to the embodiment.

FIG. 7 is a flowchart showing an example of a process at the start of charging in the provision of power-charging service of FIG. 6.

FIG. 8 is a flowchart showing an example of a process during charging in the provision of power-charging service of FIG. 6.

FIG. 9 is a flowchart showing an example of a process at the end of charging in the provision of power-charging service of FIG. 6.

FIG. 10 is an illustration showing another example of a configuration of a charging HUB apparatus according to the embodiment.

FIG. 11 is a flowchart showing an example of a power-off avoidance process during charging in the provision of power-charging service.

### DESCRIPTION OF EMBODIMENTS

Hereinafter, embodiments of the present invention are described with reference to the drawings.

A system according to an embodiment of the present invention is a system that manages a service of energy supply from an energy output section to an energy supply target. The energy output section is, for example, owned or managed by a provider that provides an energy in an energy supply service. The supplied energy may be, for example, a primary energy in the form of oil, natural gas, coal, or the like, or a secondary energy in the form of electricity, hydrogen, gasoline, light oil, heavy oil, city gas, alcohol, or the like.

A supply target to which an energy is supplied is, for example, an electric moving body driven by a motor mounted with a battery that is rechargeable from the outside (for example, an electric vehicle such as an EV (Electric Vehicle), a PHEV (Plug-in Hybrid Vehicle) and the like). The moving body may be a moving body on the ground such as an electric vehicle or a fuel cell vehicle (for example, FCV (Fuel Cell Vehicle)), an aerial moving body such as a drone, or a moving body such as a ship moving on water such as the sea. The moving body may be a vehicle having four or more wheels, a three-wheeled vehicle (tricycle), a two-wheeled vehicle (motorcycle, bicycle), a truck, a bus, a private vehicle, a commercial vehicle, or the like. The battery may be owned by the user oneself, may be leased from a leasing company, or may be owned by a business operator different from the user. Further, the supply target may be an electric device or an electronic device such as a portable or stationary home appliance, an office device and a communication terminal apparatus.

In the following embodiments, as an example, a case is described in which an energy to be used is an electric energy, an energy output section that outputs the energy is an electrical outlet that outputs an electrical energy, a supply target to which an energy is supplied is a battery for driving which is installed in a vehicle, and a system is a charging-service management system that manages a charging service (energy supply service) that charge the battery of the vehicle with the electric power output from the electrical outlet. The vehicle of the supply target in the embodiment is, for example, an electric vehicle.

In the following embodiments, the energy output section (electric-power output section) may be, for example, a charger that can quickly charge a vehicle battery in a relatively short time using direct current.

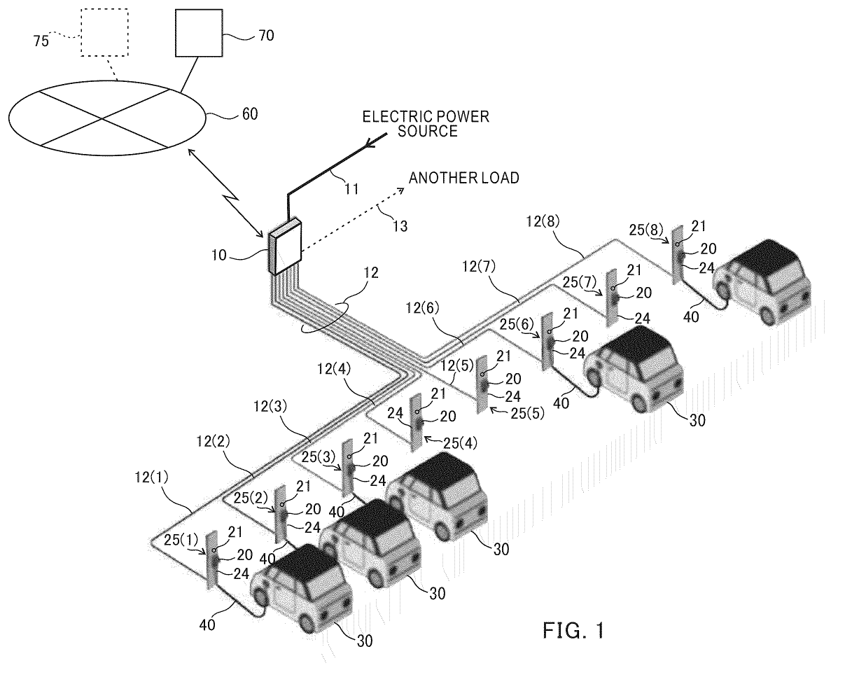

FIG. 1 is an illustration showing an example of a schematic configuration of a charging-service management system according to the embodiment. The charging-service management system of the present embodiment is a system (charging management system) that manages power charging of a plurality of vehicles 30 such as electric vehicles, etc. as supply targets (power charging targets) to which electric power is supplied from a plurality of electrical outlets 20. Although the example in FIG. 1 shows an example of a system that can charge eight vehicles 30 from eight electrical outlets 20, the number of each of the electrical outlets 20 and vehicles 30 may be 2 to 7, or may be 9 or more.

The charging-service management system includes a charging HUB apparatus (also referred to as a “charging HUB unit”) 10 as a branch apparatus. The charging HUB apparatus 10 branches a primary-side electric power line 11 as a primary-side energy supply path (electric-power supply path), which is drawn from an external electric power line of an electric power company to power distribution equipment of a facility, into a plurality of secondary-side electric power lines 12(1) to 12(8) as a plurality of secondary-side energy supply paths (electric-power supply paths). A part of the electric power supplied by the primary-side electric power line 11 is supplied to a plurality of secondary-side electric power lines 12, and the remaining electric power is supplied to another load of the facility via another electric power line 13.

The charging HUB apparatus 10 can communicate with a power-charging management server 70 as a management apparatus provided in a communication network 60 such as a mobile communication network or Internet, etc. via a radio or priority communication line. It is noted that the charging HUB apparatus 10 may communicate directly with the power-charging management server 70, or may communicate with the power-charging management server 70 via a maintenance management server 75 that remotely maintains and manages the charging HUB apparatus 10. Further, a part of the processes of the power-charging management server 70 may be performed by the maintenance management server 75, and a part or all of the processes of the maintenance management server 75 may be performed by the power-charging management server 70.

The ends of the plurality of secondary-side electric power lines 12(1) to 12(8) connected to the charging HUB apparatus 10 are respectively connected to the plurality of electrical outlets 20 provided in the charging stands 24 (for example, free-standing poles) of the electric-power output units 25(1) to 25(8) as a plurality of energy output sections that are respectively disposed in the vicinity of plural parking spaces (vehicle compartments) such as parking lots, etc. Eight sets of charging circuits are configured with the charging HUB apparatus 10, the secondary-side electric power lines 12(1) to 12(8) and the electrical outlets 20 of the electric-power output sections 25(1) to 25(8), and can charge up to eight vehicles 30 at the same time.

A code image 21 is attached near each of the electrical outlets 20 of the plurality of the charging stands 24. An electric power cable 40 from the vehicle 30 can be connected to each of the electrical outlets 20 of the plurality of charging stands 24.

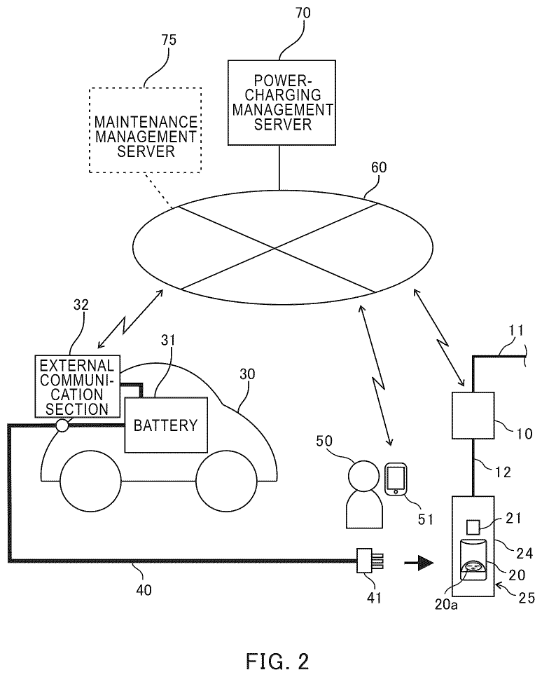

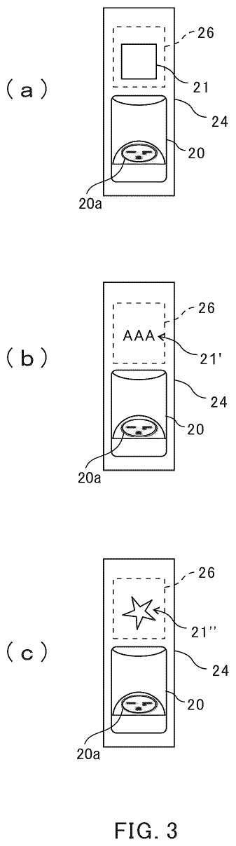

FIG. 2 is an illustration showing an example of a main part configuration of the charging-service management system according to the embodiment. In FIG. 2, the supply target in the embodiment is a battery 31 of the vehicle 30, which is charged by the electric power from the electrical outlet 20. The electric power supply from the electrical outlet 20 is performed via, for example, a wired power cable (charging cable) 40 and a plug 41. The electric power supply from the electrical outlet 20 may be performed by a radio power supply such as a power supply using radio waves such as electromagnetic induction, microwaves, etc. or a power supply by a light such as a laser light, etc. The voltage (current) supplied from the electrical outlet 20 may be alternating current (for example, AC 200V, maximum 3 to 4 kW/15 to 20A output), or may be direct current (DC 50 to 500V, maximum 50 kW).

The electrical outlet 20 shown in FIG. 2 (similar to FIG. 3 described later) is an example of a charging electrical outlet for EV/PHEV, which has a plug insertion port 20a for AC 200V (rated at 20A and 250V, with a ground terminal) on the lower surface of the electrical-outlet main body that is formed in a convex shape toward the front in the figure. The electrical outlet 20 may have an openable and closable electrical outlet cover that covers the plug insertion port 20a when the electrical outlet is not in use. Further, the electrical outlet 20 may have a function of preventing the plug 41 inserted into the plug insertion port 20a from falling off. Furthermore, the electrical outlet 20 may have a plug insertion port 20a for AC 100V (rated at 15A and 1500V, with a ground terminal). It is noted that types and configurations of the electrical outlet 20 and the plug insertion port 20a are not limited to those exemplified in FIG. 2 and FIG. 3 described later.

The charging-service management system includes a power-charging management server 70 as a management apparatus that manages an electric power (electrical energy) usage, and a maintenance management server 75 that remotely controls and maintains a device such as the charging HUB apparatus 10, etc. Each of the power-charging management server 70 and the maintenance management server 75 may be configured with a single computer apparatus, may be configured to cooperate with a plurality of computer apparatuses, or may be configured with a cloud system on a network.

The electrical outlet 20 as an electric-power output section (energy output section) 25 capable of outputting an electric power (electrical energy) is, for example, an electrical outlet provided on a wall of a facility such as a parking lot, a detached house, an apartment housing such as a condominium, an office building, an event venue, a factory, etc., or on a facility such as a stand of an outdoor or indoor parking lot, or charging equipment (charging station), etc. The electrical outlet 20 may be a general-purpose outlet with no limitation of use, or may be a dedicated outlet with a limitation of use. Further, the electrical outlet 20 may be an electrical outlet for which a user is not limited, or an electrical outlet that can be used only by a specific user.

Each of FIGS. 3(a) to 3(c) is an illustration showing an example of an image attached to the electrical outlet 20 according to the embodiment. The electrical outlet 20 in FIG. 3(a) is provided with a code image (for example, an image of a QR code (registered trademark)) 21. The code image 21 may be a one-dimensional code image or a two-dimensional code image. The code image 21 is, for example, an image in which information such as a name, identification number, installation location, and entity of outlet installation for the electrical outlet 20 is encoded. The code image 21 may be printed on a seal member 26 and attached to a side of the electrical outlet 20 by a user, an entity of outlet installation or the like.

The electrical outlet 20 in FIG. 3(b) is provided with an image of character (for example, a handwritten character) 21′ as an identification auxiliary image of the electrical outlet 20 optionally attached by a user, an entity of outlet installation or the like. Further, the electrical outlet 20 in FIG. 3(c) is provided with an image of an illustration 23 as an identification auxiliary image optionally attached by a user, an entity of outlet installation or the like. The character 21′ or the illustration 21″ may be attached to the electrical outlet 20. The character 21′ and the illustration 21″ of the electrical outlet 20 may be drawn on a seal member 26 and attached to the side of the electrical outlet 20 by the user, the entity of outlet installation or the like. It is noted that the identification auxiliary image may be a pattern or a mark, besides the character and the illustration.

A terminal apparatus 51 of a user 50 who intends to use the electric power supplied from the electrical outlet 20 can communicate with the power-charging management server 70 via a communication network 60 such as a mobile communication network or the Internet. The terminal apparatus 51 includes an operation section such as a key, a button and a touch panel, a display section such as a liquid crystal display, and an imaging section such as a camera that takes the code image of the electrical outlet, the identification auxiliary image or the like. The terminal apparatus 51 can activate and execute a predetermined power usage application (for example, a charging-service usage application) installed in advance, by being operated by the user. The terminal apparatus 51 may include a current-position acquisition section such as a GNSS receiver that acquires information on the current position of its own apparatus. The terminal apparatus 51 may be, for example, a mobile station (also referred to as a “mobile device”, “user equipment (UE)”, etc.) capable of communicating via a mobile communication network of the fourth generation or the fifth generation or the later generation.

The vehicle 30 can communicate with the power-charging management server 70 via the communication network 60 by an external communication section 32 of an in-vehicle apparatus. The external communication section 32 may be, for example, a remote control unit (TCU: Telematic Control Unit) connected to an in-vehicle network (CAN: Controller Area Network) via a gateway. The remote control unit (TCU) may have a short-range radio communication function such as wireless LAN or Bluetooth (registered trademark) in addition to the communication function via the communication network 60. The in-vehicle network (CAN) is connected to a battery management system (BMS) that manages the battery 31 and one or more electronic control units (ECU) that control other parts, in addition to the remote control unit (TCU).

Usage information of power (for example, battery identification information, amount of electric power, power-charging start time, power-charging end time) regarding the electric power used for charging the battery 31 can be transmitted, for example, from the battery management system (BMS) to the power-charging management server 70 via the remote control unit (TCU). Vehicle identification information can be transmitted, for example, from the electronic control unit (ECU) having a memory of storing basic information on the vehicle, to the power-charging management server 70 via the remote control unit (TCU). The transmission of these kinds of information to the power-charging management server 70 is executed, for example, based on a transmission request generated by the application running on the terminal apparatus 51. The transmission request from the terminal apparatus 51 may be received by the remote control unit (TCU) of the vehicle, for example, via the short-range radio communication such as a wireless LAN or Bluetooth (registered trademark).

It is noted that the power-charging management server 70 may obtain vehicle-related information such as the usage information of power, the vehicle identification information described above, etc., from, for example, a vehicle management server provided in each of the vehicle manufacturers or each of the vehicle types.

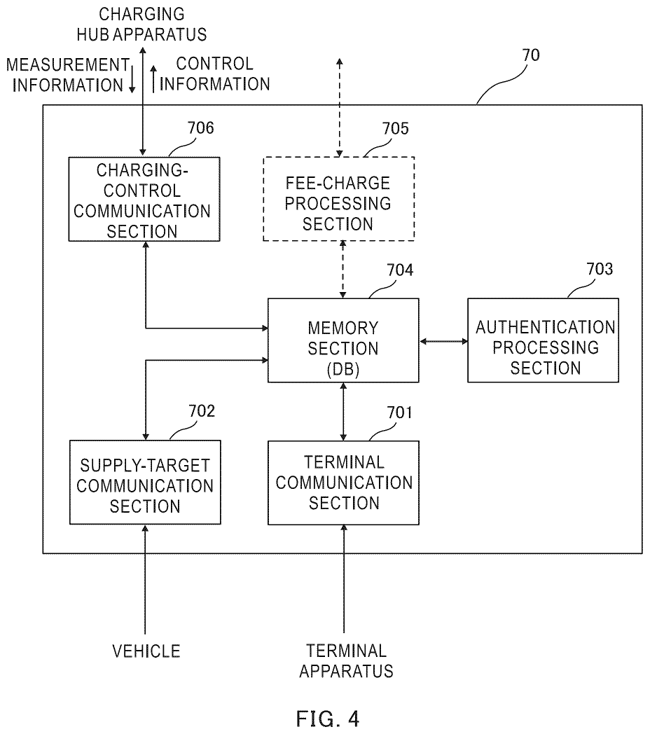

FIG. 4 is a block diagram showing an example of a configuration of main functions of the power-charging management server 70 according to the embodiment. In FIG. 4, the power-charging management server 70 includes a terminal communication section 701, a supply-target communication section 702, an authentication processing section 703, a storage section (DB: database) 704, and a charging-control communication section 706.

The terminal communication section 701 has a function of communicating with the terminal apparatus 51 of the user 50 via the communication network 60 or via another public line or dedicated line.

In an example of the charging service management, the terminal communication section 701 receives a read data of the code image (for example, the image of the QR code (registered trademark)) 21 (see FIG. 3(a)) attached to the electrical outlet 20, identification information of the user 50 or the terminal apparatus 51, and identification information of a supply target to which an electric power is supplied from the electrical outlet 20 (for example, identification information of the vehicle 30 or the battery 31), from the terminal apparatus 51 of the user 50 via the communication network 60. The read data of the code image 21 may be, for example, an image data obtained by taking the code image 21 with the camera of the terminal apparatus 51, or may be a data obtained by decoding the image data.

In another example of the charging service management, the terminal communication section 701 receives a read data of the identification auxiliary image 21′ or 21″ (see FIG. 3(b) and FIG. 3(c)) attached to the electrical outlet 20, position information of the terminal apparatus 51, and identification information of the user 50 or the terminal apparatus 51 and identification information of a supply target to which an electric power is supplied from the electrical outlet 20 (for example, identification information of the vehicle 30 or the battery 31), from the terminal apparatus 51 of the user 50. The read data of the identification auxiliary image 21′ or 21″ is, for example, an image data obtained by taking the identification auxiliary image 21′ or 21″ with the camera of the terminal apparatus 51. The position information of the terminal apparatus 51 is, for example, the position information (latitude, longitude, altitude) of the terminal apparatus 51, which is measured by the GNSS receiver of the terminal apparatus 51.

The supply-target communication section 702 has a function of communicating with the supply target vehicle 30 via the communication network 60 or via another public line or dedicated line. The supply-target communication section 702 receives, for example, the identification information of the supply target (for example, identification information of the vehicle 30 or the battery 31), and the charging information as usage information of power (for example, battery identification information, an amount of electric power, a power-charging start time, a power-charging end time) supplied from the electrical outlet 20 and used in the vehicle 30, from the vehicle 30. The supply-target communication section 702 may receive the identification information of the supply target and the charging information from the vehicle management server described above.

The charging-control communication section 706 has a function of communicating with the charging HUB apparatus 10 via the communication network 60 or via another public line or dedicated line, and functions as information receiving means, information generating means and information transmitting means.

The charging-control communication section 706 receives, for example, information of measurement results of an electric power, an electric current or an amount of electric power as energy supply status of the primary-side electric power line 11, information of measurement results of an electric power, an electric current or an amount of electric power as energy supply status of the plurality of secondary-side electric power lines 12(1) to 12(8), or information of both of the measurement results. Based on the information of the measurement results of the primary side or the secondary side or based on the information of the measurement results of the primary side and the secondary side, the charging-control communication section 706 generates control information for individually opening and closing each of the secondary-side electric power lines 12(1) to 12(8) in the eight sets of charging circuits, and transmits the control information to the charging HUB apparatus 10.

The control information may be, for example, control information for monitoring the charging status in each parking space (vehicle compartment) based on information of the measurement results of an electric power, an electric current or an amount of electric power of each of the plural secondary-side electric power lines 12(1) to 12(8), and controlling so as to perform a plurality of charges via each of the plural secondary-side electric power lines 12(1) to 12(8), in a time-sharing and distributed manner.

The control information may be, for example, control information for controlling to close at least one of the secondary-side electric power lines 12(1) to 12(8) in the eight sets of charging circuits, when the measurement result of the electric power, electric current or amount of electric power as energy supply status of the primary-side electric power line 11 exceeds a predetermined threshold value (for example, a target demand value), or when the measurement result is predicted to exceed the threshold value. By controlling to close the at least one of the plurality of secondary-side electric power lines 12(1) to 12(8) based on this control information by the charging HUB apparatus 10, total electric power, electric current and amount of electric power of the primary-side electric power line 11 can be reduced, and an unexpected cutoff of power supply can be avoided in a facility such as a parking lot, a detached house, an apartment such as a condominium, an office building, an event venue, a factory that shares the primary-side electric power line 11, and the like.

The control information may include, for example, information of priority ranking of electric power supply (priority ranking of charging) to each of the secondary-side electric power lines 12(1) to 12(8) in the eight sets of charging circuits. Based on this priority ranking information, the charging HUB apparatus 10 controls so as to perform a preferential charging in which an electric power is preferentially supplied to some of the plurality of secondary-side electric power lines 12(1) to 12(8).

The control information may include information of interruptive electric power supply (interruptive charging) in the secondary-side electric power lines 12(1) to 12(8) in the eight sets of charging circuits. Based on this information of interruptive electric power supply (interruptive charging), the charging HUB apparatus 10 stops the electric power supply to the secondary-side electric power line that is currently supplying the electric power, among the plurality of secondary-side electric power lines 12(1) to 12(8), and controls so as to perform an interruptive charging to start an electric power supply to another secondary-side electric power line through which an electric power supply is currently stopped.

The priority ranking of electric power supply (priority ranking of charging) and the interruptive electric power supply (interrupt charging) are determined, for example, based on a method such as a policy-based, a rule-based, or a machine learning model, etc., to maximize the charging efficiency or fee-charging operation for the entire charging from the electrical outlet via the secondary-side electric power lines 12(1) to 12(8) in the eight sets of charging circuits. The policy-based method is, for example, a method for determining the priority ranking (priority ranking of charging) in the plurality of vehicles 30 of charge targets and whether or not to allow an interruptive charging for the vehicles 30 based on current charging status information and supply target information, etc., by a program created based on preset policy information. The rule-based method is, for example, a method for determining the priority ranking (priority ranking of charging) in the plurality of vehicles 30 of charge targets and whether or not to allow an interruptive charging for the vehicles 30 from current charging status information and supply target information, etc., by a conversion table created based on preset rules. The machine-learning model method is, for example, a method for creating a learned model by learning on a preset machine learning model using the data of charging information and vehicle information obtained when performing past charging services, and determining the priority ranking (priority ranking of charging) in the plurality of vehicles 30 of charge targets and whether or not to allow interrupt charging for the vehicles 30 based on the learned model, current charging status information and supply target information, etc.

It is noted that the terminal communication section 701, the supply-target communication section 702 and the charging-control communication section 706 may be configured with an integrally configured communication apparatus (for example, a mobile communication module).

The authentication processing section 703 performs at least one of an authentication (user authentication) of the user who uses an electric power and an authentication (supply target authentication) of the supply target (for example, the vehicle 30 or the battery 31), based on the identification information of the user 50 or the terminal apparatus 51 and the identification information of the supply target (for example, the identification information of the vehicle 30 or the battery 31).

For example, the authentication processing section 703 may perform the user authentication for confirming whether the user 50 is a regular user registered in advance in a predetermined charging service, by comparing the identification information (user ID) of the user 50 received from the terminal apparatus 51 with the identification information (user ID) of the user registered in advance in the power-charging management server 70. In this case, the use of the charging service may be permitted when the user is the regular user, and the use of the charging service may be restricted (for example, the use is not permitted) when the user is not the regular user.

Further, for example, the authentication processing section 703 may perform the supply target authentication for confirming whether the supply target (for example, the vehicle 30 or the battery 31) is a regular supply target registered in advance in the predetermined power-usage management service, by comparing the identification information of the supply target (for example, the identification information of the vehicle 30 or the battery 31) received from the terminal apparatus 51 with the identification information of the supply target (for example, the identification information of the vehicle 30 or the battery 31) received from the vehicle 30. In this case, the use of the power-usage management service may be permitted when the supply target is the regular supply target, and the use of the power-usage management service may be restricted (for example, the use is not permitted) when the supply target is not the regular supply target. It is noted that, in this authentication, the identification information of the supply target (for example, the identification information of the vehicle 30 or the battery 31) received from the terminal apparatus 51 or the vehicle 30 may be compared with the identification information of the supply target registered in advance in the power-charging management server 70 to perform the authentication process.

In an example of the charging service management, the storage section (DB) 704 specifies the identification information of the electrical outlet 20 and the identification information of the charging HUB apparatus 10 to which the electrical outlet 20 is connected, based on the read data of the code image, and stores the identification information (outlet ID) of the electrical outlet 20, the identification information (HUB ID) of the charging HUB apparatus 10, the identification information of the user 50 or the terminal apparatus 51, the identification information of the supply target (for example, identification information of the vehicle 30 or the battery 31), and the usage information of power, in association with each other. For example, as shown in TABLE 1, for each of series of power usage transactions, one record is recorded, in which the outlet ID, the user ID, the terminal ID (for example, IMEI), the vehicle ID and the electric-power usage information are associated with each other, and a power-usage transaction table (power usage ledger) is formed as a whole.

TABLE 1

| | | | | | Usage Information |
|---|---|---|---|---|---|
| Outlet ID | HUB ID | User ID | Terminal ID (IMEI) | Vehicle ID | of Power |
| 00001 | 00001 | 00001 | AA-BBBBBB-000001-D | 00001 | X1Y1 |
| 00011 | 00010 | 00002 | AA-BBBBBB-000002-D | 00100 | X1Y2 |
| . . . | | . . . | | . . . | . . . |

In another example of the charging service management, the storage section (DB) 704 specifies the identification information of the electrical outlet 20 based on the above-mentioned read data of the identification auxiliary image and the current position information of the terminal apparatus 51, and stores the identification information (outlet ID) of the electrical outlet 20, the identification information of the user 50 or the terminal apparatus 51, the identification information of the supply target (for example, identification information of the vehicle 30 or the battery 31) and the usage information of power, in association with each other.

The storage section (DB) 704 also stores various tables used for the charging service management via a plurality of electrical outlets. For example, the storage section (DB) 704 stores an outlet management table in TABLE 2, a user management table in TABLE 3 and a vehicle management table in TABLE 4.

TABLE 2

| | | | | | Identification- | | |
|---|---|---|---|---|---|---|---|
| Outlet | HUB | | Position | Installer | Auxiliary | Registration | |
| ID | ID | Name | Information | ID | Image | Date | . . . |
| 00001 | 00001 | AAAAA | 00, 00, 00 | 00001 | ***** | 2019 Jun. 1 | . . . |
| 00002 | 00001 | BBBBB | 00, 00, 00 | 00002 | ****** | 2019 Jun. 1 | . . . |
| . . . | | . . . | . . . | . . . | . . . | . . . | . . . |

TABLE 3

| User | | Benefit for | Registration | |
|---|---|---|---|---|
| ID | Terminal ID (IMEI) | Fee-Charging | Date | . . . |
| 00001 | AA-BBBBBB-000001-D | 1 | 2019 May 1 | . . . |
| 00002 | AA-BBBBBB-000002-D | 0 | 2019 May 10 | . . . |
| . . . | . . . | . . . | . . . | . . . |

TABLE 4

| Vehicle | Battery | Registration | |
|---|---|---|---|
| ID | ID | Date | . . . |
| 00001 | AAAAA | 2019 May 1 | . . . |
| 00002 | AAAAB | 2019 May 10 | . . . |
| . . . | . . . | . . . | . . . |

A new record is added to each of the outlet management table, the user management table and the vehicle management table, when the electrical outlet 20, the user 50 (terminal apparatus 51) and the vehicle 30 (battery 31) for using the charging service via the electrical outlet 20 provided by the power-charging management server 70 in the present embodiment are newly registered. By referring to the outlet management table in TABLE 2, it is possible to construct a public-outlet virtual space indicating positions of public outlets that the user can newly register in the charging service provided by the power-charging management server 70 in the present embodiment. By superimposing and displaying this public-outlet virtual space on a map of the real space, the user can easily figure out and access the positions of public outlets that can be newly registered by the user.

The storage section (DB) 704 may also store a registered outlet table shown in TABLE 5. A record is added to this registered outlet table when the user newly registers the electrical outlet 20. By connecting and referring to the registered outlet table and the above-mentioned various tables, it is possible to construct a My Outlet virtual space indicating positions of registered outlets that the user can use in the charging service provided by the power-charging management server 70 in the present embodiment. By superimposing and displaying this My Outlet virtual space on a map of the real space, the user can easily figure out and access positions of electrical outlets that can be registered and used by the user.

TABLE 5

| Outlet | HUB | User | Registration | |
|---|---|---|---|---|
| ID | ID | ID | Date | . . . |
| 00001 | 00001 | 00101 | 2019 Jul. 1 | . . . |
| 00002 | 00001 | 00102 | 2019 Jul. 15 | . . . |
| . . . | | . . . | | . . . |

In the present embodiment, the power-charging management server 70 may be provided with a fee-charge processing section 705. The fee-charge processing section 705 performs a process of fee-charging to at least one of the user 50, the supply target (vehicle 30 or battery 31) and the terminal apparatus 51, with respect to a usage fee of power usage by the vehicle 30 via the electrical outlet 20. For example, all or a part of the usage fee of power usage by the vehicle 30 via the electrical outlet 20 may be charged to the user 50 or may be fee-charged so as to be added to the usage fee for the terminal apparatus 51. If the vehicle 30 or the battery 31 is rented from a rental company or leased from a leasing company, all or a part of the usage fee of the power usage by the vehicle 30 via the electrical outlet 20 may be charged to the rental company or the leasing company.

The fee-charging process of the power usage may be performed in consideration of various benefits (benefits for fee-charging) related to the fee-charging. For example, in case that an environmental value certificate such as a “Green Power Certificate”, “J Credit” and “Non-fossil Certificate” that certify the environmental value of renewable energy such as a wind power, solar power and biomass, or something of equivalent value (hereinafter referred to as “environmental value such as the environmental value certificate”) is considered to be added to the electric current supplied to the vehicle 30 via the electrical outlet 20, the status of adding the environmental value such as the environmental value certificate may be managed by, for example, a flag in the column of benefit for fee-charging of the user management table in TABLE 3, and the environmental value may be charged (increase or decrease) in parallel with the amount of electric power. The presence or absence of the benefit for fee-charging such as a purchase of the environmental value such as the environmental value certificate can be managed by, for example, a flag in the column of benefit for fee-charging of the user management table in TABLE 3.

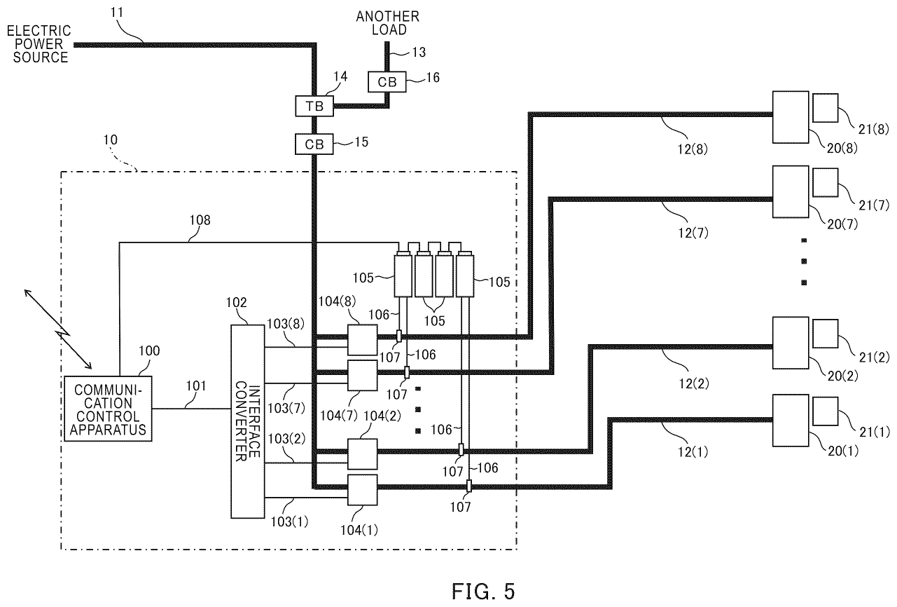

FIG. 5 is an illustration showing an example of the configuration of the charging HUB apparatus 10 according to the embodiment. In FIG. 5, the primary-side electric power line 11 is connected to the charging HUB apparatus 10 via a terminal box (TB) 14 and a circuit breaker (CB) 15 for charging. The primary-side electric power line 11 is branched at the TB 14 and connected via another circuit breaker (CB) 16 to another load other than the vehicle charging circuit (for example, various types of electrical devices other than charging in parking lots, an electrical device in a residential area of a detached house and an apartment housing such as a condominium, an electrical device in each office of an office building, an electrical device in an event venue, an electrical device in a factory, etc.).

The primary-side electric power line 11 connected to the charging HUB apparatus 10 is branched into the secondary-side electric power lines 12(1) to 12(8) in the eight sets of charging circuits.

The charging HUB apparatus 10 includes a communication control apparatus 100, an interface converter 102 as a control-data conversion apparatus, remote control breakers 104(1) to 104(8) having a plurality of remote control relays as switching means for opening and closing the secondary-side electric power lines 12(1) to 12(8), and an electric-power amount monitoring apparatus 105 as measuring means for measuring the amount of electric power of the secondary-side electric power lines 12(1) to 12(8).

The communication control apparatus 100 is, for example, configured with a microcomputer capable of reading and executing a predetermined control program for controlling the opening and closing, etc., of the secondary-side electric power lines 12(1) to 12(8), and has a function of communicating with the power-charging management server 70 or the maintenance management server 75. The interface converter 102 is, for example, connected to the communication control apparatus 100 via a LAN cable 101, converts control information data received from the communication control apparatus 100, into control signals, and transmits the control signals to each of the plural remote control breakers 104(1) to 104(8).

Each of the plurality of remote control breakers 104(1) to 104(8) is connected to the interface converter 102 via a predetermined signal line. When each of the remote control breakers 104(1) to 104(8) receives a control signal corresponding to an ON command from the communication control apparatus 100, it closes the circuit of the secondary-side electric power lines 12(1) to 12(8) (circuit continuity status), and when it receives a control signal corresponding to an OFF command from the communication control apparatus 100, it opens the secondary-side electric power lines 12(1) to 12(8) (circuit cutoff status).

The electric-power amount monitoring apparatus 105 is, for example, connected to a split-type current transformer 107 as a current sensor attached to each of the secondary-side electric power lines 12(1) to 12(8) via a dedicated cable 106. The measurement data of amount of electric power of each of the secondary-side electric power lines 12(1) to 12(8) measured by the electric-power amount monitoring apparatus 105 is transmitted to the communication control apparatus 100 via a cable 108 of a dedicated interface (for example, RS485 serial interface).

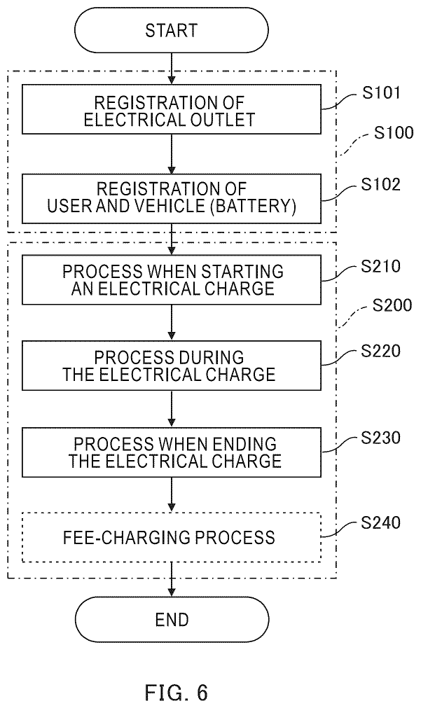

FIG. 6 is a flowchart showing an example of a process of a provision of power-charging service according to the embodiment. In FIG. 6, the process of the provision of power-charging service in the present embodiment includes a preparation phase (S100) and an operation phase (S200).

In the preparation phase (S100), with respect to the plurality of electrical outlets 20 to be used by the power-usage management service, data inputs to the power-charging management server 70 are performed by an operator, the power-charging management server 70 creates the outlet management table in TABLE 2 described above. The power-charging management server 70 also creates the user management table in TABLE 3 and the vehicle management table in TABLE 4, by receiving new registration data including the information of the users 50 and the terminal apparatuses 51 and the information of the supply targets (vehicle 30 and battery 31), from the terminal apparatuses 51 of a plurality of users 50 who use the charging service.

The operation phase (S200) includes a process S210 at the start of power charging, a process S220 during power charging, and a process S230 at the end of power charging, and may include a fee-charging process S240 as an optional process.

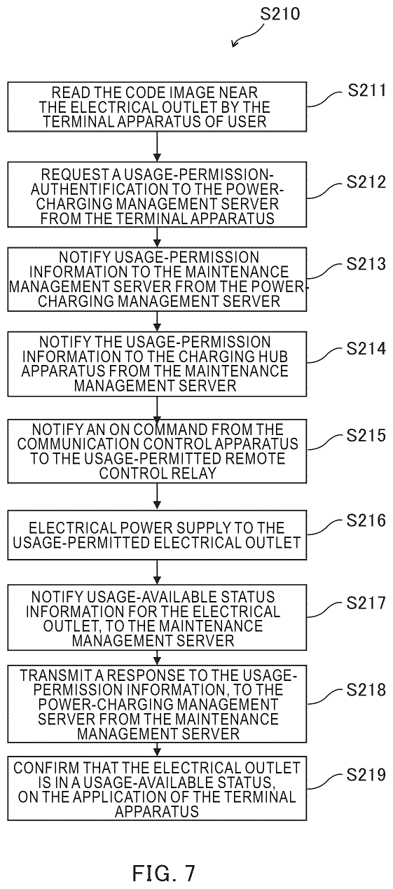

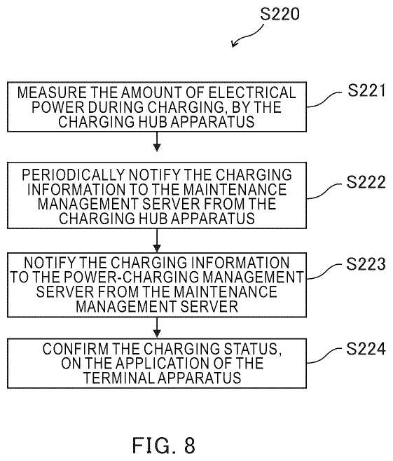

FIG. 7 is a flowchart showing an example of a process at the start of charging (S210) in the provision of power-charging service of FIG. 6. It is noted that in the example of FIG. 7, although the power-charging management server 70 performs a control by communicating with the charging HUB apparatus 10 via the maintenance management server 75, the power-charging management server 70 may perform a control by communicating with the charging HUB apparatus 10 without going through the maintenance management server 75 (the same applies to FIGS. 8 to 11 below).

In FIG. 7, first, the user 50 operates the terminal apparatus 51 to activate an application for using the charging service, takes and reads the code image (for example, a QR code (registered trademark)) 21 including the identification information of the electrical outlet 20, which is disposed near the electrical outlet 20, and selects “my car” from a menu selection displayed on the display screen of the terminal apparatus 51 (S211). By this operation, a usage-permission authentication of the charging service is requested from the terminal apparatus 51 to the power-charging management server 70 (S212). When making this request, the identification information of the user 50 (or the terminal apparatus 51), the read data of the code image 21 and the identification information of the vehicle 30 (or the battery 31) pre-registered as “my car” in the terminal apparatus 51 are transmitted to the power-charging management server 70.

Next, when the power-charging management server 70 receives the request of the usage-permission authentication including the identification information of the user 50 (or the terminal apparatus 51), the read data of the code image 21 and the identification information of the vehicle 30 (or the battery 31) from the terminal apparatus 51 of the user 50, the power-charging management server 70 performs an authentication process with respect to a combination of the identification information of the user 50 (or the terminal apparatus 51) and the vehicle 30 (or the battery 31), based on the identification information of the user 50 (or the terminal apparatus 51) and the identification information of the vehicle 30 (or the battery 31) which are received from the terminal apparatus 51. Herein, if the electrical outlet 20 is not registered for the user 50, the power-charging management server 70 newly registers the outlet IDs of the electrical outlet 20 and the user IDs corresponding to each other, into the above-described registered outlet table in TABLE 5, as an electrical outlet that can be used by the user 50.

When the above authentication process is completed, the power-charging management server 70 notifies the usage-permission information including the electrical outlet ID of the control target, to the maintenance management server 75 (S213). When receiving the usage-permission information from the power-charging management server 70, the maintenance management server 75 notifies the usage-permission information to the communication control apparatus 100 of the charging HUB apparatus 10 (S214).

The communication control apparatus 100 of the charging HUB apparatus 10 pre-stores the correspondence data between the electrical outlet ID and the identification information of the remote control breaker (remote control relay), and upon receiving the usage-permission information from the maintenance management server 75, the communication control apparatus 100 notifies the ON command to the usage-permitted remote control breaker (remote control relay) 104 corresponding to the electrical outlet ID, based on the electrical outlet ID included in the usage-permission information (S215).

When receiving the ON command from the communication control apparatus 100, the usage-permitted remote control breaker (remote control relay) 104 closes the circuit of the corresponding secondary-side electric power line 12 (circuit continuity status), and starts an electric power supply (for example, AC 200V) to the corresponding electrical outlet 20 (S216).

The communication control apparatus 100 of the charging HUB apparatus 10 notifies usage-available status information, which indicates that the corresponding electrical outlet 20 is in a usage available status for charging, to the maintenance management server 75, based on the open/close information from the remote control breaker (remote control relay) 104 (S217). Upon receiving notification of the usage-available status information from the charging HUB apparatus 10, the maintenance management server 75 transmits a response to the foregoing usage-permission information to the power-charging management server 70 (S218).

When the power-charging management server 70 receives the response to the usage-permission information, the user 50 can confirm that the electrical outlet 20 is in a usage-available status, on the application of the terminal apparatus 51 (S219).

FIG. 8 is a flow chart showing an example of a process during charging (S220) in the provision of power-charging service of FIG. 6. In FIG. 8, when starting the charging to the vehicle 30 from the electrical outlet 20, the charging HUB apparatus 10 measures the amount of electric power [kWh] during charging in the secondary-side electric power line 12 of the electrical outlet 20, by using the electric-power amount monitoring apparatus 105 (S221).

The communication control apparatus 100 of the charging HUB apparatus 10 periodically notifies charging information including information of the foregoing measured amount of electric power during charging, to the maintenance management server 75 (S222), and the maintenance management server 75 notifies the charging information received from the charging HUB apparatus 10 to the power-charging management server 70 (S223).

When the power-charging management server 70 receives the charging information, the user 50 can check the charging status of the vehicle 30 from the electrical outlet 20 on, the application of the terminal apparatus 51 (S224).

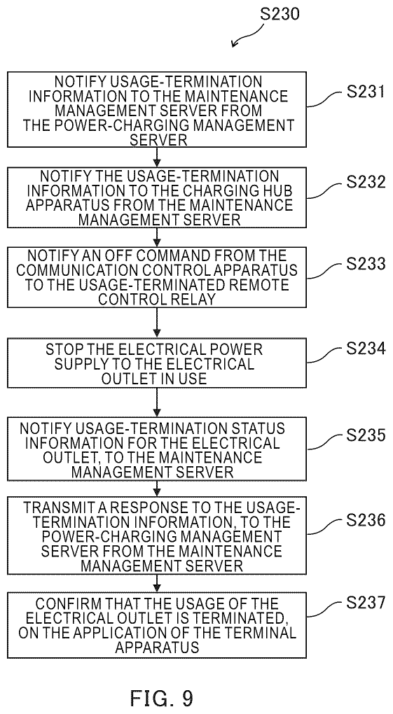

FIG. 9 is a flowchart showing an example of a process at the time of charging completion (S230) in the provision of power-charging service in FIG. 6. When the power-charging of the battery 31 of the vehicle 30 by the electric power supplied from the electrical outlet 20 is completed, the vehicle 30 transmits, to the power-charging management server 70, the identification information of the supply target (the identification information of the vehicle 30 or the battery 31) and the usage information of power supplied from the electrical outlet 20 and used to charge the battery 31 of the vehicle 30, upon the request of the terminal apparatus 51 of the user 50 or autonomously. The power-charging management server 70 receives, from the vehicle 30, the identification information of the supply target (the identification information of the vehicle 30 or the battery 31) and the usage information of power.

In FIG. 9, when receiving the information from the vehicle 30, the power-charging management server 70 notifies usage-termination information including the electrical outlet ID of the electrical outlet of the termination target, to the maintenance management server 75 (S231). When receiving the usage termination information from the power-charging management server 70, the maintenance management server 75 notifies the usage termination information to the communication control apparatus 100 of the charging HUB apparatus 10 (S232).

When receiving the usage termination information from the maintenance management server 75, the communication control apparatus 100 of the charging HUB apparatus 10 notifies the OFF command to the usage-terminated remote control breaker (remote control relay) 104 corresponding to the electrical outlet ID, based on the electrical outlet ID included in the usage termination information (S233).

When receiving the OFF command from the communication control apparatus 100, the usage-terminated remote control breaker (remote control relay) 104 opens the circuit of the corresponding secondary-side electric power line 12 (circuit cutoff status) and stops the electric power supply (for example, AC 200V) to the corresponding electrical outlet 20 (S234).

The communication control apparatus 100 of the charging HUB apparatus 10 notifies information of usage termination status, which indicates that the charging from the corresponding electrical outlet 20 is in a termination status, to the maintenance management server 75, based on the open/close information from the remote control breaker (remote control relay) 104 (S235). When receiving the notification of the information of usage termination status from the charging HUB apparatus 10, the maintenance management server 75 transmits a response to the foregoing usage termination information, to the power-charging management server 70 (S236).

When the power-charging management server 70 receives the response to the usage termination information, the user 50 can confirm that the usage of the electrical outlet 20 has been terminated, on the application of the terminal apparatus 51 (S237).

The power-charging management server 70 refers to the above-described outlet management table in TABLE 2 based on the read data of the code image, and specifies the identification information of the electrical outlet 20. Further, the power-charging management server 70 stores, in the storage section (DB) 104, the identification information (outlet ID) of the electrical outlet 20, the identification information (user ID, terminal ID) of the user 50 or the terminal apparatus 51, the identification information of the supply target (vehicle ID or battery ID) and the power usage information, so as to associate them with each other and add them to the above-mentioned power-usage transaction table (power usage ledger) in Table 1.

The power-charging management server 70 can manage the power usage of each user via the electrical outlet in the power-usage management service by referring to the power-usage transaction table (power usage ledger).

It is noted that the power-charging management server 70 may perform a process of fee-charging to at least one of the user 50, the supply target (the vehicle 30 or the battery 31) and the terminal apparatus 51, with respect to the usage fee of the power usage by the vehicle 30 via the electrical outlet 20, by referring to the power-usage transaction table (power usage ledger) (S240 in FIG. 6 described above).

In case of using the identification auxiliary image 21′ or 21″ (see FIG. 3(b) and FIG. 3(c)) attached to the electrical outlet 20, in step S211 in FIG. 7, the power-charging management server 70 receives the read data of the identification auxiliary image 21′ or 21″ and the position information of the terminal apparatus 51 from the terminal apparatus 51, instead of the read data of the code image. Further, in step S211 in FIG. 7, the power-charging management server 70 refers to the above-mentioned outlet management table in Table 2 based on the read data of the identification auxiliary image 21′ or 21″ and the position information of the terminal apparatus 51, and specifies the identification information of the electrical outlet 20.

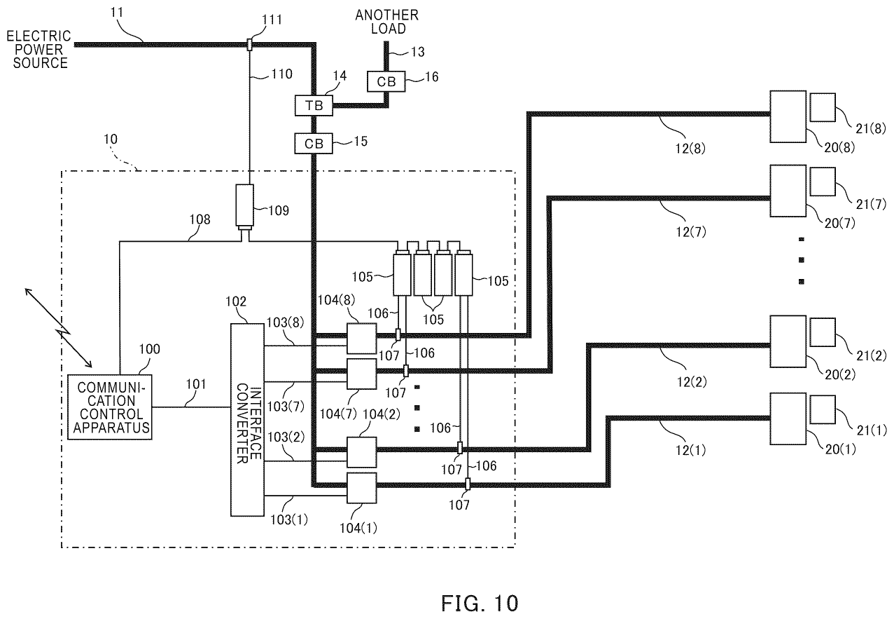

FIG. 10 is an illustration showing another example of the configuration of the charging HUB apparatus according to the embodiment. In the configuration example of FIG. 10, the charging HUB apparatus 10 includes an electric-power amount monitoring apparatus 109 as measuring means for measuring the amount of electric power of the primary-side electric power line 11. It is noted that the other configurations in FIG. 10 are the same as those in FIG. 5 described above.

The electric-power amount monitoring apparatus 109 is connected to a split-type current transformer 111 as a current sensor, which is attached to the primary-side electric power line 11 via a dedicated cable 110. The measurement data of the amount of electric power of the primary-side electric power line 11 measured by the electric-power amount monitoring apparatus 109 is transmitted to the communication control apparatus 100 via the cable 108 of the above-mentioned dedicated interface (for example, RS485 serial interface). The measurement data of the amount of electric power of the primary-side electric power line 11 can be used, for example, in a power-off avoidance process during charging.

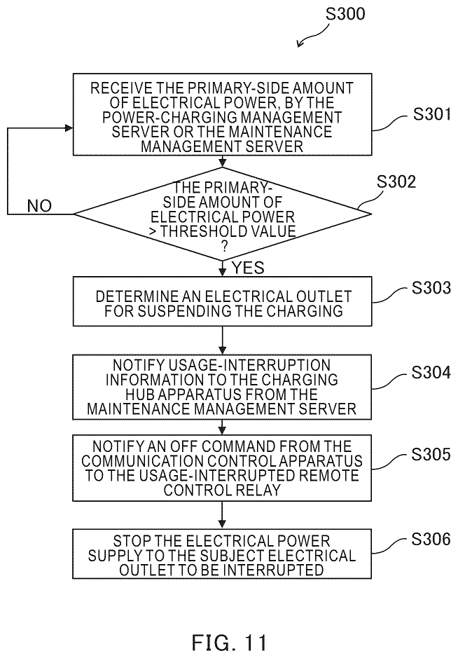

FIG. 11 is a flowchart showing an example of a power-off avoidance process during charging (S300) in the provision of power-charging service.

In FIG. 11, the power-charging management server 70 or the maintenance management server 75 periodically receives measurement data of the amount of electric power of the primary-side electric power line 11, which is measured by the charging HUB apparatus 10 (S301), and determines whether the amount of electric power of the primary-side electric power line 11 exceeds a predetermined threshold value (for example, a target demand value) or whether the measured data is predicted to exceed the threshold value (S302).

When the power-charging management server 70 or the maintenance management server 75 determines that the amount of electric power of the primary-side electric power line 11 exceeds the predetermined threshold value (for example, a target demand value) (or the measurement data is predicted to exceed the threshold value) (YES in S302), it determines an electrical outlet for suspending the charging, from among the electric outlets 20 used for charging (S303). For this determination, the information of the priority ranking of electric power supply (priority ranking of charging) described above may be used.

Next, the maintenance management server 75 notifies usage-interruption information including the electrical outlet ID of the electrical outlet of charging interruption target, to the communication control apparatus 100 of the charging HUB apparatus 10 (S304).

When the communication control apparatus 100 of the charging HUB apparatus 10 receives the usage-interruption information from the maintenance management server 75, it notifies an OFF command to the usage-interruption remote control breaker (remote control relay) 104 corresponding to the electrical outlet ID, based on the electrical outlet ID included in the usage-interruption information (S305).

When the usage-interruption remote control breaker (remote control relay) 104 receives the OFF command from the communication control apparatus 100, it opens the circuit of the corresponding secondary-side electric power line 12 (circuit cutoff status) and stops the electric power supply (for example, AC 200V) to the corresponding electrical outlet 20 (S306). Thereby, total electric power, electric current and amount of electric power of the primary-side electric power line 11 can be reduced, and an unexpected cutoff of power supply can be avoided in a facility such as a parking lot, a detached house, an apartment housing such as a condominium, an office building, an event venue, a factory, etc. that shares the primary-side electric power line 11.

As described above, according to the present embodiment, when branching the primary-side electric power line 11 into the plurality of secondary-side electric power lines 12(1) to 12(8) to supply electric power to and charge the plurality of vehicles 30, the electric power supply to the plurality of vehicles 30 can be remotely monitored and efficiently controlled.

According to the present embodiment, it is possible to perform an efficient fee-charging operation and control for the electrical outlets and charger groups in the charging circuits (up to 8 sets of charging circuits in the embodiment) of the plurality of secondary-side electric power lines 12(1) to 12(8) branched from the primary-side electric power line 11.

According to the present embodiment, the status of charging in the charging circuit of the plurality of secondary-side electric power lines 12(1) to 12(8) can be monitored, and the charging control necessary for charging the vehicle 30 such as an electric vehicle, etc. can be performed remotely from the power-charging management server 70 configured with a cloud system.

According to the present embodiment, the charging-service provision system includes a scalability for performing the priority power charging and the interruptive power charging, based on a policy-based, a rule-based, a machine learning model, or the like.

According to the present embodiment, the amount of electric power of the main breaker (primary-side electric power line) is measured, and if it exceeds the target demand value (threshold value), the charging to the vehicle 30 such as an electric vehicle, etc. can be controlled to avoid a power supply cutoff of the entire facility that shares the primary-side electric power line.

Further, according to the present embodiment, it is possible to realize the power-usage management with authentication, with respect to the electric power supplied from the electrical outlet 20 and used for charging the battery 31 of the vehicle 30, without providing an additional apparatus in the electrical outlet 20.

It is noted that process steps and configuration elements such as information processing apparatuses, terminal apparatuses, and in-vehicle apparatuses of vehicles described in the present specification can be implemented with various means. For example, these process steps and configuration elements may be implemented with hardware, firmware, software, or a combination thereof.

With respect to hardware implementation, means such as processing units or the like used for establishing the foregoing steps and configuration elements in entities (for example, computer apparatus, server, terminal apparatus (user equipment, mobile station, communication terminal), in-vehicle apparatus of vehicle, hard disk drive apparatus, or optical disk drive apparatus) may be implemented in one or more of an application-specific IC (ASIC), a digital signal processor (DSP), a digital signal processing device (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing units or the like for using to establish the foregoing configuration elements may be implemented with a program (for example, a code such as a procedure, a function, a module, an instruction, etc.) for performing a function described in the present specification. In general, any computer/processor readable medium of clearly materializing the code of firmware and/or software may be used for implementation of means such as processing units and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage unit, or the like. The code may be executed by one or more of computers and processors, and a certain aspect of functionalities described in the present specification may be executed by a computer or processor.

The foregoing medium may be a non-temporary recording medium. The foregoing code of the program may be readable and executable by a computer, processor, or other device or apparatus machine, and its format is not limited to a specific format. For example, the foregoing code of the program may be any of source code, object code, and binary code, or may be a mixture of two or more of these codes.

The description of embodiments disclosed in the present specification is provided so that the present disclosures can be produced or used by those skilled in the art. Various modifications of the present disclosures will be readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: charging HUB apparatus
20, 20(1) to 20(8): electrical outlet
21, 21(1) to 21(8): code image
30: vehicle
31: battery
32: external communication section
40: power cable
41: plug
50: user
51: terminal apparatus
60: communication network
70: power-charging management server
75: maintenance management server

1. A branch apparatus for branching a primary-side energy supply path into a plurality of secondary-side energy supply paths, comprising:
secondary-side measurement means for measuring an energy supply status in each of the plurality of secondary-side energy supply paths;
opening/closing means for opening and closing each of the plurality of secondary-side energy supply paths; and
control means for transmitting information of measurement results of the secondary-side measurement means to a management apparatus, receiving control information generated based on the information of the measurement results of the secondary-side measurement means, from the management apparatus, and controlling the opening/closing means to individually open and close each of the plurality of secondary-side energy supply paths based on the control information.

2. The branch apparatus according to claim 1, comprising primary-side measurement means for measuring energy supply status in the primary-side energy supply path,
wherein the control means transmits information of measurement results of the primary-side measurement means to the management apparatus, receives control information generated based on the information of the measurement results of the primary-side measurement means, from the management apparatus, and controls the opening/closing means to individually open and close each of the plurality of secondary-side energy supply paths based on the control information.

3. The branch apparatus according to claim 2,
wherein the primary-side measurement means measures an amount of energy supply in the primary-side energy supply path, and
wherein the control means controls the opening/closing means so as to close at least one of the plurality of secondary-side energy supply paths when a measurement result of the amount of energy supply in the primary-side energy supply path exceeds a predetermined threshold value, or when the measurement result is predicted to exceed the threshold value.

4. The branch apparatus according to any one of claims 1 to 3,
wherein the control information includes information of priority ranking of energy supply to each of the plurality of secondary-side energy supply paths, and
wherein the control means controls the opening/closing means to preferentially supply an energy to a part of the plurality of secondary-side energy supply paths based on the information of the priority ranking received from the management apparatus.

5. The branch apparatus according to any one of claims 1 to 4,
wherein the control information includes information of interruptive energy supply in the plurality of secondary-side energy supply paths, and
wherein the control means stops an energy supply to a secondary-side energy supply path that is currently supplying an energy, among the plurality of secondary-side energy supply paths, based on the information of interruptive energy supply received from the management apparatus, and controls the opening/closing means so as to start an energy supply to another secondary-side energy supply path that is stopping the energy supply.

6. The branch apparatus according to any one of claims 1 to 5,
wherein the control means receives control information from the management apparatus, the control information being generated based on at least one of information of a supply target to which an electric power is supplied via the secondary-side energy supply path and information of the measurement results of the secondary-side measuring means, and controls the opening/closing means to individually open and close each of the plurality of secondary-side energy supply paths based on the control information.

7. The branch apparatus according to any one of claims 1 to 6,
wherein the energy supplied via the secondary-side energy supply path is an electrical energy used for charging a battery mounted on a vehicle,
wherein each of the primary-side energy supply path and the plurality of secondary-side energy supply paths is an electric power line, and
wherein the energy supply status to be measured is an electric power, an electric current or an amount of electric power.

8. A system for providing a power charging service of a vehicle, comprising:
a branch apparatus according to claim 7;
a management apparatus capable of communicating with the branch apparatus via a communication network; and
a plurality of electric-power output sections for outputting an electric power supplied via each of the plurality of secondary-side energy supply paths, and
wherein the management apparatus comprises:
information receiving means for receiving information of the measurement results from the branch apparatus;
information generating means for generating control information for individually opening and closing each of the plurality of secondary-side energy supply paths based on the information of the measurement results; and
information transmitting means for transmitting the control information to the branch apparatus.

9. The system according to claim 8,
wherein the management apparatus comprises fee-charging processing means for performing a process of fee-charging a usage fee for power charging by the vehicle via the electric-power output section to at least one of the user of the power charging service of the vehicle, the vehicle, a battery installed in the vehicle and a terminal apparatus operated by the user, based on the information of the measurement results of the secondary-side measurement means, for each of the plurality of electric-power output sections.
